(19) United States
(12) Patent Application Publication
(10) Pub. No.: US 2014/0224211 A1
(43) Pub. Date: Aug. 14, 2014

(54) FLUID PRESSURE SOURCE FROM A PRIME MOVER

(71) Applicant: ROGER L. SWEET, Deputy, IN (US)

(72) Inventor: ROGER L. SWEET, Deputy, IN (US)

(21) Appl. No.: 13/763,744

(22) Filed: Feb. 11, 2013

(51) Int. Cl. F02M 63/00

(52) U.S. Cl. CPC F02M 63/00
USPC 123/434

(57) ABSTRACT

A direct use of combustion fluid from cylinder(s) of a prime mover is used to supply compressible fluid to a pneumatic system. The fluid is extracted from combustion chamber(s)(2) during the compression and power cycles. The fluid is cooled, filtered, and dried to provide a clean media for the pneumatic system.

### BACKGROUND

U.S. Pat. No. 5,636,611 to Frankle 1997 Jun. 10, describes a similar embodiment to this disclosure in that engine compression fluids are extracted and stored in a tank. The method is a timed valve in the engine head to vent compressed intake air to the tank. Should the remaining compressed air in the combustion chamber not attain adequate Pressure, the ignition and power cycle will not occur. The engine will display a decrease in power because one (or more) of the cylinders is not contributing torque. It will display a “miss” and tend to run “rough”. This invention extracts compression fluids at a much reduced and controlled flow rate via an orifice. Enough cylinder pressure will remain to support ignition and the power cycle. The engine will continue to support ignition and the power stroke. The output power of the engine will be slightly reduced, but hold the governed speed without a “miss” or stumble.

U.S. Pat. No. 6,269,792 by Hakansson Aug. 7, 2001 also discusses a similar system using an “extra exhaust valve” and a system to shut the fuel off. It deals with the lack of power cycles so the resulting “vibration” is made less frequent.

This invention operates with a much less complex system which will reduce cost and improve reliability.

This invention will be retrofitable on current engines with a minimum of time and cost.

This invention isn't required to consume the resources of current engine components.

With the implementation of EPA's “2007 Highway Rule”, heavy-duty tracks and buses have been required to use ultra-low sulfur diesel beginning in 2006. This was a large step in cleaning up emissions and particles in combustion gases. Today, combustion gases have become a much more likely fluid for external fluid power uses.

### BRIEF DESCRIPTION OF DRAWING

FIG. 1 shows a schematic representation of a fluid pressure source from a prime mover according to the invention.

### DESCRIPTION OF THE INVENTION

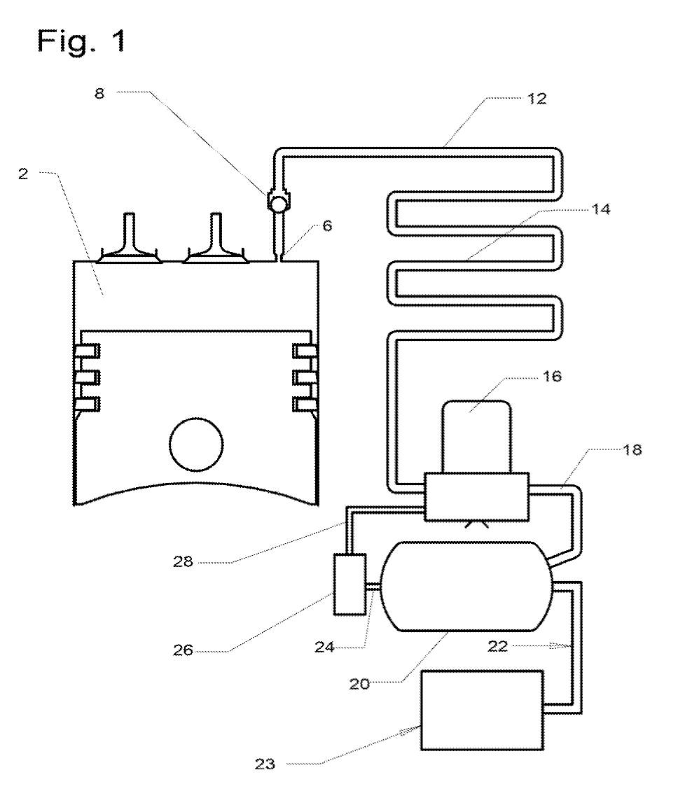

### Preferred Embodiment Using FIG. 1

Prime movers create high pressures in a combustion chamber (2) during compression and power cycles. During the pressurized phases, fluid flows out through a flow control orifice (6). The fluid flow continues through a flow checking device (8) and to a passage (12). The fluid continues through a flow cooling device (14) to a flow filtering and drying device (16). The flow continues through to passage (18) and continues to a flow storing tank (20). The flow will continue through passage (22) to the reservoir(23). As a pneumatic system requires fluid, it will be supplied from reservoir (23). A pressure governing valve (26) communicates with tank (20) through a passage (24). At the high pressure limit within tank (20), pressure governing valve (26) will communicate a pressure signal to drying device (16) through passage (28). The presence of pressure in passage (28) to drying device (16) causes it to block flow from flow cooling device (14) and shuts off fluid flow to passage (18). Drying device (16) will be in the regeneration mode. When the pressure in tank (20) gets to the low pressure limit, pressure governing device (26) will remove the pressure signal from passage (28). Fluid flow will be reinstated in drying device (16).

The unobvious element is the use of combustion fluids for an external working fluid. With the implementation of EPA standards for engines and fuel, the combustion fluids have become much cleaner, which enables this use. This invention also includes filtering and drying device(16) to additionally clean and neutralize any errant gases that may be produced.

### SUMMARY

Present prime movers use a dedicated mechanical compressor mounted on the engine to pump air on demand to the air supply tanks of the vehicle. This air has been cooled, filtered and dried. This invention is a method to eliminate the compressor, free up the attachment mounting for other uses on the engine, and improve the efficiency and cost of converting combustion fluids to compressed fluid for pneumatic system use. The engine creates high pressures of fluid in the compression, and power cycles. The invention describes how to capture small quantities of combustion fluids and process it to use in the pneumatic system.

What is claimed is:

1. A prime mover of a vehicle enabled to extract fluid out of a combustion chamber (2).

2. The prime mover of claim 1 in that the extraction of fluid is performed by a flow control means (6).

3. The prime mover of claim 2 adding a flow checking means (8).

4. The prime mover of claim 3 in that more than one said combustion chamber (2) can be used to supply fluid.

5. The prime mover of claim 4 comprises of a flow cooling means (4) for the fluid sources.

6. The prime mover of claim 5 additionally routing the fluids into a flow filtering and drying means (16).

7. The prime mover of claim 6 additionally routing the fluid flow into a flow storing means (20).

8. The prime mover of claim 7 additionally including a pressure governing valve (26).

9. The prime mover of claim 8 additionally including a reservoir (23) that supplies a pneumatic system.
